(19) United States
(12) Patent Application Publication
(10) Pub. No.: US 2009/0192827 A1
(43) Pub. Date: Jul. 30, 2009

(54) System for health benefits planning in retirement

(76) Inventors: Linda Sue Andersen, Silver Spring, MD (US); Christopher E. Hansen, Olympia, WA (US); Lynne C. MacArthur, Olympia, WA (US)

Correspondence Address: MCKENNA LONG & ALDRIDGE LLP, 1900 K Street, N.W., Washington, DC, 20006, US

(21) Appl. No.: 12/010,756

(22) Filed: Jan. 29, 2008

(51) Int. Cl. G06Q 40/00

(52) U.S. Cl. 705/4

(57) ABSTRACT

A rules-based expert system is described in which the information relating to health or retirement benefits are stored in the form of statements or clauses relating to financial, medical, or personal characteristics relevant to statue or regulation at issue. The statements, or rules, are stored in a rules engine, or knowledge base in the form of “If X, then Y.” The specific construction of the data declarations relating to retirement and health benefit planning relies on parsing federal, state, and local regulations and statutes regarding Medicare, Medicaid, Social Security, as well as general health insurance and long-term care insurance. The rules are applied to the user characteristics and to data about available policies to identify the policies most likely to be of greatest benefit and least cost to the user.

### BACKGROUND OF THE INVENTION

1. Field of the Invention

The present invention relates to retirement health benefit planning, and expert systems and inference rules engines for implementing the same.

2. Discussion of the Related Art

The number of people over 65 is expected to almost double, to 71 million, by 2030. As this generation enters retirement, the demand for post-retirement health and financial planning is likely to soar. The health insurance market for this population is increasingly complex. Private insurance is heavily regulated by a web of federal and state laws. Medicare, Medicaid and other government programs are expanding to meet the demand for prescription drugs and more technologically sophisticated health care. Employers look for a way to move away from costly retirement insurance forcing retirees to look for alternatives to finance ongoing medical care. The anticipated costs of long term care for this generation are daunting. To ensure ongoing benefits and coverage, individuals must gather a great deal of information in order to understand their health benefit choices and anticipate the future cost of these choices.

Current sources for retirement health benefit planning information vary depending on the age and wealth of the individual. Increasingly, financial planners focusing on retirement investments must be able to answer questions about the variety of health insurance choices and guide their clients with assets toward understanding Medicare and private health insurance and associated costs. Individuals without financial planners must rely on family members and others who lack expertise about Medicare, Medigap, Medicaid and other insurance necessary to meet retirement health care costs.

Further, even if consumers have a general understanding of their health insurance choices, they do not have the information necessary to compare one plan to another, nor do they know how to identify which plan is best for them. The consumer suffers from incomplete information not only about the plans but about how to evaluate the plans given their particular circumstances. From the retail or financial planners' perspective, there is no current means by which the costs of retirement heath care can be estimated and retirement health benefit planning can be integrated effectively into their overall financial planning workflow.

The plethora of publications in the marketplace does not meet this consumer need. These materials either lack sufficient detail to elucidate choices effectively, or are too complex for the layperson to easily understand. Some of these include: the U.S. Department of Health and Human Services, Centers for Medicare and Medicaid annual publication, “Medicare and You,” Insurance for Dummies by Jack Hungelmann; Health Insurance Resource Manual: Options for People with a Chronic Disease or Disability by Dorothy E. Northrop, Stephen E. Cooper, and Health Care on Less Than You Think, The New York Times Guide to Getting Affordable Coverage by Fred Brock. By their very nature, written publications are unable to manipulate the wide variety of personal economic and health care factors to provide comprehensive assistance and too rapidly become outdated.

Furthermore, conventional software programs and interactive applications have also been ineffective. For example, several health insurance websites selling health insurance will ask a limited number of questions to obtain information to assess the individual's eligibility only for individual or self-employment private health insurance. For example, see: http://www.ehealthinsurance.com. However, if an individual user with Medicare answers the Medicare question affirmatively, the site advises the user that it does not sell insurance to individuals with Medicare. This site fails to provide information about health insurance choices after retirement. Benefits Checkup, developed by the National Council on Aging, is an online service to identify public and private benefits and services available to individuals across the country. See: http://www.benefitscheckup.org. Individuals are required to enter information about income and assets, place of residence, etc. to obtain information about a wide variety of public benefit programs including prescription drug benefits, discount programs and possible Medicaid eligibility. This site, however, is not tailored specifically for health insurance and health benefits information. It does not ask enough questions about the individual's circumstances to provide information about the best, or recommended, health benefit choices for that particular individual. Instead, the site asks questions geared to determine potential eligibility for all public benefit programs-state tax relief for older individuals, Food Stamps, Veterans' benefits, for example, but does not advise them regarding when to apply for Medigap insurance, enroll in Medicare, or help in determining whether they should consider long-term care insurance.

Given the diversity and complexity of options facing present and soon-to-be retirees, what is needed is a single, unified approach to retirement health benefit planning that analyzes the wide variety of available health benefits, the legal and regulatory constraints on these benefits, and the individual's personal health and economic factors to recommend a set of health benefit choices and the costs of these alternatives.

### SUMMARY OF THE INVENTION

Accordingly, the present invention is designed as a system for recommending retirement health benefit plans by obtaining specific demographic, financial and workforce information about the user and using this information to substantially obviate one or more of the problems due to limitations and disadvantages of the related art.

An advantage of the present invention is to provide a system for recommending one retirement benefit plan out of a large set of plans based on data about a user.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

Other advantages and in accordance with the purpose of the present invention, as embodied and broadly described, a system for recommending a retirement benefit plan includes a database to store and retrieve data specific to individual users and data relating to retirement benefit plans, each of said plans having a specific set of values associated with it, each of said values being associated with a particular characteristic. A plurality of rules is stored in an inference rules engine, at least one of said rules relating a specific plan characteristic to another characteristic. These rules are implemented within the inference rules engine by comparing said user data with the values associated with the plan characteristics, thereby determining a recommended plan.

As additionally embodied, the present invention includes a computerized method of recommending a retirement benefit plan, including storing in a computer readable medium a plurality of rules in the form of conditional statements having a condition and a result, at least one of said rules having at least one specific value for at least one characteristic associated with an eligibility requirement of a retirement plan in the condition, and having the name of the plan in the result; generating a plurality of questions based on said rules, at least one of said questions asking for data about a plan beneficiary; receiving data about a plan beneficiary; processing data about said plan beneficiary and comparing said data to said specific value of the condition of the at least one rule; and outputting a report recommending a retirement benefit plan corresponding to the plan in the result of the statement of the at least one rule if the condition is satisfied.

Furthermore, the computerized method of recommending a retirement benefit plan according to claim 9, further comprising identifying all of the rules whose conditions are not satisfied by the data received and eliminating these rules as a basis for generating subsequent questions.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a schematic diagram of the components of a system according to a first embodiment of the present invention;

FIG. 2 illustrates a table summarizing data, rules, and recommendations according to the present invention; and

FIG. 3 illustrates a process according to an exemplary embodiment of the present invention.

### DETAILED DESCRIPTION OF THE ILLUSTRATED EMBODIMENTS

The present invention addresses the problems inherent in existing retirement health benefit planning solutions. The present invention addresses health insurance eligibility across the private insurance spectrum—employment health benefits including extensions of these benefits under COBRA as well as the individual health insurance marketplace. In addition, the present invention expands or contracts the number of questions presented to the user based on answers to previous questions. These questions ask for specific user information to provide integrated health insurance benefit information to the user. The system of the present invention offers consumers a solution for determining the best retirement health benefit plan available for them given their particular set of circumstances without requiring them to learn anything about the plans themselves or about retirement planning in general. The system of the present invention also offers professional financial planners the ability to integrate retirement health benefit planning into their overall workflow through a client-server based interface customized for them, their brand, and their process. Reference will now be made in detail to an embodiment of the present invention, example of which is illustrated in the accompanying drawings.

The system of the present invention according to a first embodiment is a web-based client-server environment, with the software, databases, business, and presentation logic all residing on one or more computer systems on the server side (hereinafter “the server”). The user interfaces with the system through a web browser, however it is understood to be within the scope of the invention that a software application running locally may access the server for business and runtime logic as well as for database access, but that the user interface may be accomplished by the locally running software.

In this exemplary embodiment, the present invention relies on an expert system. An expert system is a computer system that stores data and rules about a given subject. It analyzes the data in light of the rules to arrive at a conclusion, make a decision, or present a set of possible choices. In particular, the preferred expert system is a computer system based around one or more computer algorithms and databases that contains health and retirement benefit information derived from statutes, tax codes, Medicare, Medicaid, Social Security and insurance tables or the like. The expert system employs an inference rules engine to implement appropriate algorithms.

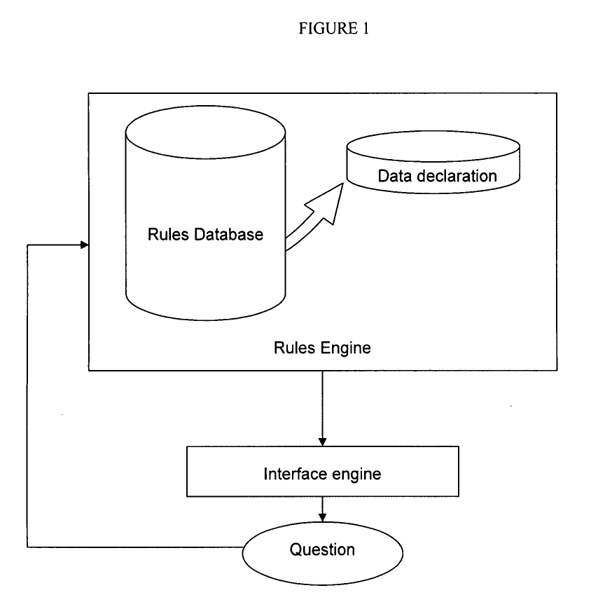

An expert system according to this first embodiment is illustrated generally in FIG. 1. In a first aspect of this embodiment, algorithms may be stored in the form of conditional statements or clauses relating to financial, medical, or personal characteristics relevant to statue or regulation at issue. Conditional statements or rules are stored in an inference rules engine. Typically the rules are stored in the form of “If X, then Y.” The specific construction of the rules relating to retirement health benefit planning is based on parsing federal, state, and local regulations and statutes regarding Medicare, Medicaid, Social Security, HIPAA, ERISA, veterans' benefits, TRICARE, as well as general health and long-term care insurance.

In addition to storing the data and inference rules, the system also stores multiple sets of recommendations that the system will make when the user has completed entering in all of the requested data. The sets of recommendations may be any one or a combination of health benefit plans, long term care plans, or financial or insurance products. Users may obtain different sets of recommendations that reflect different user assumptions about future circumstances, such as residence location, marital status, income, or relative health.

The system of the present invention may use forward chaining or backward chaining machine reasoning algorithms to determine the data that need to be obtained from the user, and the order in which they should be obtained. Forward chaining starts with the data obtained by the system so far, and uses the rule declarations to determine what additional data are needed and to present appropriate questions to collect more data until a set of recommendations can be made. Backward chaining occurs when a user changes an assumption used to reach a set of recommendations, and works backwards through the data submitted by the user to identify data items that need to be updated, or were not required for the previous set of recommendations and now need to be collected to allow the system to make a new set of recommendations.

The order in which data are to be obtained from the user is not stored in the system. Rather, navigational rules are stored in the inference rules engine. Once the navigation rule declarations are defined, they are used by the system to determine which data are needed, and an optimal sequence for asking questions that minimizes the time required for the user to enter data. Questions are associated with each piece of data that the system could possibly require, and stored as text on web pages. The stored question includes parameter placeholders for the system to replace with particular pieces of data that have already been obtained. If the parametric placeholder is correct, no entry is required of the user. This provides for a more user-friendly experience.

The user interface provides the questions to the user. As the user answers the questions, the system queries the inference rules engine to determine the next question to ask. To obtain all of the necessary data from the user in the most efficient manner, the system may invoke any of a number of optimization methods. In one aspect, the system determines which data items are required by the most inference rules, and prompts for that data first. In another aspect, the system prompts for personal data first, and then prompts for data used in inference rules that will allow the system to cull the greatest number of possible recommendations, thus arriving at an optimal set of recommendations sooner. For example, if Medicare and Medicare-related retirement benefits are available only to those above a certain age, the system could prompt the user for their age early in the process (or calculate it based on their birth date), and if the age is too young to qualify for Medicare-related benefits, cull all further questions or prompts from the set of all possible questions. Doing so would accelerate the process because the total universe of possible next questions would be considerably smaller. In still another aspect, the system determines which inference rules are implicated most frequently by the set of possible recommendations, to determine a set of data that is likely to be needed from any user of the system.

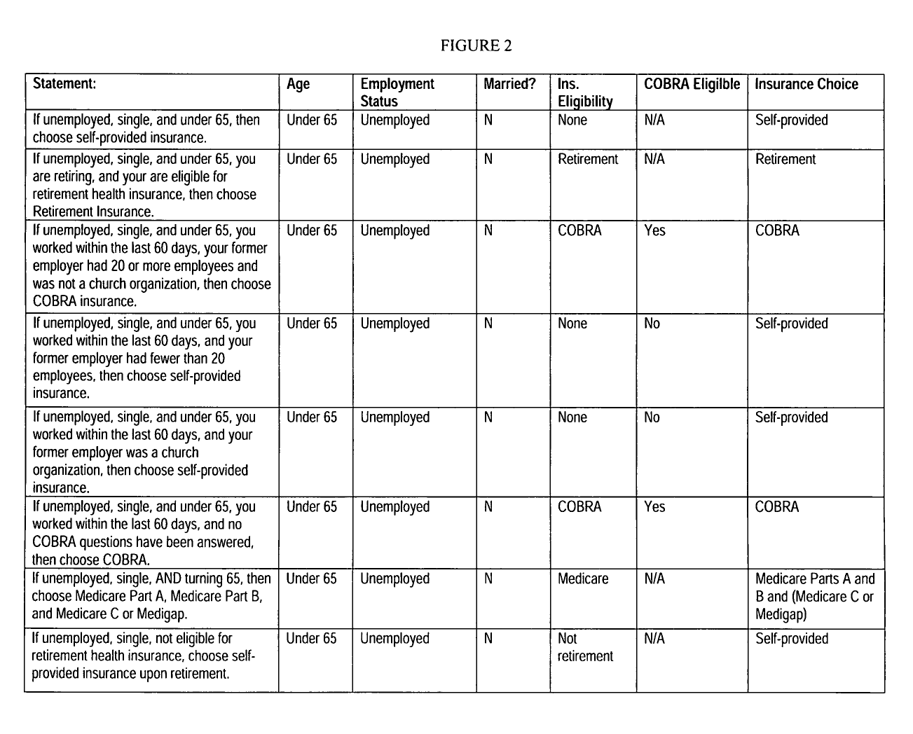

An example of the series of questions a user may be asked in a portion of the system of the present invention is illustrated in FIG. 2 relating to health status, marital status, income and desired premium. The questions and prompts illustrated in FIG. 2, implemented in a rules engine similar to that portrayed by FIG. 1, illustrate merely the questions as they may be presented to the user. In particular, in this embodiment, the endpoints may not be termination points of the program but would link to other processes, or request other information needed to achieve a final result. Accordingly, FIG. 2 illustrates only a portion of the universe of possible questions that the system is capable of asking the user.

The rules engine or expert system of the present exemplary embodiment is stateless, or path-independent. The determination of what data to ask for next is not based on the path of inference rules implemented in the system up to that point. Rather, the system considers the set of data already provided, and prompts for the next data item according to the inference rule to be checked next (which is in turn determined by the particular optimization algorithm used).

As the system collects data, it ranks the possible recommendations based on some predetermined or user-selected criteria. For example, if a criterion is to minimize the monthly premium of a health plan, the possible recommendations would be ranked by cost. Multiple criteria may also be ranked. For example, if the user prefers a plan that has long-term care coverage over those that do not, but among plans that provide such coverage, the user prefers those with lower monthly premiums, the system would rank those with long term coverage higher than those without, and then rank those with the long-term care coverage by monthly premium.

The manner in which the recommendations are presented may also vary depending on predetermined or user-determined criteria. For example, the system may present a list of the ten highest ranked recommendations, or it may simply present the highest ranked alone.

In a further aspect of the invention, because the system operates in a web-based environment, each of the recommendations presented may be associated with a specific plan offered for sale through a third-party provider. The third party provider would pay the system operator to have their plans associated with the recommendations. In an alternative, the system operator may randomize the third-parties whose specific plans are associated with the recommendations, and charge the third party a per click fee whenever the user who is presented with the recommendations and plans clicks through to a specific plan. Thus, while the recommendations are determined through the systems rule based engine, and is sponsor or advertiser independent, the recommendations may be associated with specific plans on the market that have the specific characteristics recommended by the system.

In another aspect, the system may be integrated into a larger financial planning toolkit of a commercial customer. In such an implementation, the system would have a consistent branding and appearance, and the specific recommended plan types are presented in the form of the customer's branded plans or products that are of the recommended type.

In an alternative implementation, while the types of plans recommended by the system are determined solely based on the user's personal information and the health benefit plan information stored in the rules engine, the plan recommendation may be presented in the form of sponsor's plans that are of the type or have the characteristics as the plan type recommended, however, the sponsor pays for placement of their particular plans in users' results pages.

The operation of the system will be discussed with reference to FIG. 2. The system of this embodiment of the present invention is loaded with rules relating to two long term care plans A and B with varying monthly premiums depending on current health and marital status as well as a maximum allowable income. For example, Health Plan A may be a government funded low-income assistance plan such as Medicaid with an income cap of $50,000, whereas Plan B may be a private long term care insurance plan. FIG. 2 does not list the inference rules themselves, but rather compiles the various data requirements of a number of rules relating to each of the plans.

Based on FIG. 2, the expert system of the present invention will determine that it needs to obtain the marital status, income status, and health status of the user. However, depending on the data obtained for income, it may not be necessary to also obtain the health status. If the user's income is less than $50,000, then while Plan B is a possible result, it will never be recommended because the premium is always higher than for Plan A. Thus it is not necessary for the system to inquire about health status, and will simply prompt for income and marital status, and make the recommendation on that basis. In this case, although three distinct data items are needed to fully rank all of the possibilities, the system determines that one of those data items will reduce the number of possible outcomes by two-thirds and will reduce the number of data items needed by one-third.

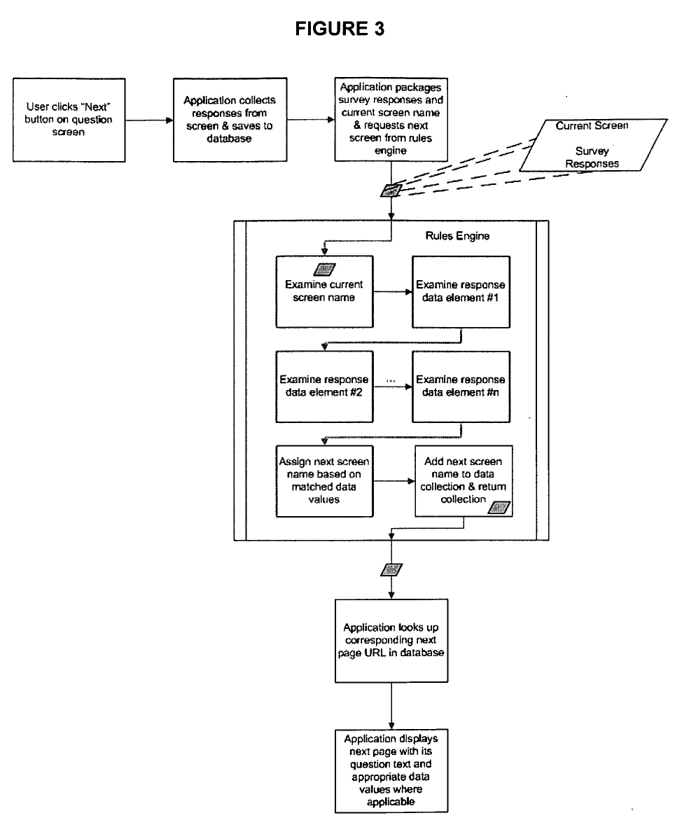

By way of another example, when a user clicks the “Next” button on any screen that displays survey questions, in the present embodiment, the system proceeds as follows to determine the next question to ask. Data from the current screen are collected and stored in the database. The collection of responses to all questions (including empty values for those that have not been asked or have been skipped) are sent to the rules engine, along with a coded name for the current screen and the direction of navigation. The rules engine treats each screen as a potential “branching point” for navigation, using its name and the combination of survey responses to determine what the next page should be. For example, if the current screen is ‘insInsured’, ‘marital status’ is ‘Single’, ‘health insurance status’ is ‘false’, and ‘employment status’ is either ‘Is Employed’ or ‘Employed Part Time’, then the next screen is ‘insEmpl’. This exemplary process is illustrated in FIG. 3.

Other combinations of responses would result in the determination of a different screen for the next question. Upon receiving the response from the rules engine, the application uses the coded name for the screen to look up (in the application database) the actual page name to be displayed and displays that page. The page is displayed, showing the corresponding question as stored on the page, and filling placeholders in the text with actual values from the collection of existing survey responses.

Similarly, when the user has successfully navigated to the final question, clicking the “Next” button results in a call to the rules engine where a separate set of rules is applied to determine the appropriate insurance recommendations from the completed set of responses to all relevant questions.

Although the example illustrated in FIG. 2 is a simple case, presented for ease of understanding, it is understood that the invention covers systems with thousands of possible recommendations, rules, and data values. Thus, efficient ordering of questions can significantly reduce both the amount of time required by the user to enter their information and obtain a recommendation, as well as the amount of data items they will need to collect in order to complete the system.

A more detailed example of an example of a rule with all rules engine information included is as follows:

### Rule Number: 1

### Preconditions/Filters:

insCrit.age<65
insCrit.employmentStatus=‘Is Employed’ or insCrit.employmentStatus=‘Employed Part Time’
insCrit.maritalStatus=‘Single’

### Conditions:

NOT ins→exists (insuranceType=‘Employer’,recommended<>‘T’)
NOT events3→exists (lifeEventName=‘uponRetirement’)
NOT events4→exists (lifeEventName=‘uponLeavingJob’)
NOT events5→exists (lifeEventName=‘upon65’)

### Actions:

insCrit.postInfo
ins+=Insurance.newUnique[Insurance.insuranceType=‘Employer’,recommended=‘T’]

### Statement:

If under 65, employed and single AND not enrolled in company plan, choose employer's insurance.

Additional rules within this ruleset (with the rules engine information omitted) would be as follows. Note, these are provided by way of example only, and it is understood that the same rules could be implemented in a variety of different ways and still be within the scope of the invention.

### Rule Number: 2

Statement: If under 65, employed and single AND enrolled in company plan, COBRA eligible, UPON leaving job choose COBRA.

### Rule Number: 3

Statement: If under 65, employed and single AND enrolled in company plan, not COBRA eligible UPON leaving job (because employer did not have 20 or more employees), choose self-provided insurance.

### Rule Number: 4

Statement: If under 65, employed and single AND enrolled in company plan, not COBRA eligible UPON leaving job (because employer was a church organization), choose self-provided insurance.

### Rule Number: 5

Statement: If under 65, employed and single and NOT enrolled in company plan (and therefore COBRA ineligible), UPON leaving job choose self-provided insurance.

### Rule Number: 6

Statement: If under 65, employed AND single, UPON leaving job AND turning 65, choose Medicare A, B, and C.

### Rule Number: 7

Statement: If under 65, employed and single AND enrolled in company plan, not retirement eligible, COBRA eligible UPON retirement, choose COBRA.

### Rule Number: 8

Statement: If under 65, employed and single AND enrolled in company plan, not COBRA eligible UPON retirement (because employer did not have 20 or more employees) and not retirement insurance eligible, choose self-provided insurance.

### Rule Number: 9

Statement: If under 65, employed and single AND enrolled in company plan, not COBRA eligible UPON retirement (because employer is a church organization) and not retirement insurance eligible, choose self-provided insurance.

### Rule Number: 10

Statement: If under 65, employed and single AND retirement eligible, UPON retirement, choose retirement insurance.

### Rule Number: 11

Statement: If under 65, employed and single AND not retirement eligible, COBRA eligible UPON retirement AND turning 65, choose Medicare A, B, and C.

### Rule Number: 12

Statement: If under 65, employed and single AND not eligible for retirement or employment insurance, choose self insurance.

### Rule Number: 13

Statement: If under 65, employed and single AND retirement eligible, UPON retirement AND turning 65, choose Medicare A and B and Retirement.

### Rule Number: 14

Statement: If under 65, employed and single AND enrolled in company plan, not retirement insurance eligible, but COBRA eligible, UPON going to part time choose COBRA.

### Rule Number: 15

Statement: If you have turned 65, employed, single and going to part time choose Medicare A, B and C.

### Rule Number: 16

### Statement:

If under 65, employed and single AND enrolled in company plan, not retiring, COBRA eligible, UPON going to part time choose COBRA.

### Rule Number: 17

Statement: If under 65, employed and single AND enrolled in company plan, not COBRA eligible UPON going to part time (because employer had fewer than 20 employees), choose self-provided insurance.

### Rule Number: 18

Statement: If under 65, employed and single AND enrolled in company plan, not COBRA eligible UPON going to part time (because employer was a church organization), choose self-provided insurance.

### Rule Number: 19

Statement: If under 65, employed and single AND enrolled in company plan, and life event is Now, stay with employer's insurance.

### Rule Number: 20

Statement: If currently employed and enrolled in the company plan, single, and turning 65, then choose employer-provided healthcare and Medicare A.

### Rule Number: 21

Statement: If currently employed and not enrolled in the company plan, single, and turning 65, then choose Medicare A, Medicare B, and Medicare COR Medigap.

A portion of the ruleset relating to question processing as described above in reference to FIG. 3 is as follows:

Rulesheet: incomeScreens

### Rule Number: 1

Statement: If the current screen is {incSSElig} then the next screen is {‘incSSSpouse}. Direction is {Forward }. Marital status is {Single}. Person who worked 10 years for SS is {Spouse}.

### Rule Number: 2

Statement: If the current screen is {incSSElig} then the next screen is {incSSBenefit}. Direction is {Forward}. Marital status is {Single}.Person who worked 10 years for SS is {Me}.

### Rule Number: 3

Statement: If the current screen is {incSSElig} then the next screen is {incSSParents}. Direction is {Forward}. Marital status is {Single}.Person who worked 10 years for SS is {Spouse, Me}. ERD status is {True}

### Rule Number: 4

Statement: If the current screen is {incSSElig} then the next screen is {incSSBenefit}. Direction is {Forward}. Marital status is {Single}. Person who worked 10 years for SS is {Spouse, Me}. ERD status is {False}

### Rule Number: 5

Statement: If the current screen is {incSSElig} then the next screen is {healthERDALS}. Direction is {Backward}. Marital status is {Single}.

### Rule Number: 6

Statement: If the current screen is {incSSSpouse} then the next screen is {incSSBenefit}. Direction is {Forward}. Marital status is {Single}.

### Rule Number: 7

Statement: If the current screen is {incSSSpouse} then the next screen is {incSSWidowed}. Direction is {Forward}. Marital status is {Single}. Social Security Married is True.

### Rule Number: 8

Statement: If the current screen is {incSSSpouse} then the next screen is {incSSElig}. Direction is {Backward}. Marital status is {Single}.

### Rule Number: 9

Statement: If the current screen is {incSSWidowed} then the next screen is {incSSBenefit}. Direction is {Forward}. Marital status is {Single}.

### Rule Number: 10

Statement: If the current screen is {incSSWidowed} then the next screen is {incSSSpouse}. Direction is {Backward}. Marital status is {Single}.

### Rule Number: 11

Statement: If the current screen is {incSSParents} then the next screen is {incSSBenefit}. Direction is {Forward}. Marital status is {Single}.

### Rule Number: 12

Statement: If the current screen is {incSSParents} then the next screen is {incSSElig}. Direction is {Backward}. Marital status is {Single}.

### Rule Number: 13

Statement: If the current screen is {incSSBenefit} then the next screen is {incEmploy}. Direction is {Forward}. Marital status is {Single}. The User's Social Security benefits application status is {False, null}.

### Rule Number: 14

Statement: If the current screen is {incSSBenefit} then the next screen is {incSSBeginDate}. Direction is {Forward}. Marital status is {Single}. The User's Social Security benefits application status is {True}.

### Rule Number: 15

Statement: If the current screen is {incSSBenefit} then the next screen is {incSSElig}. Direction is {Backward}. Marital status is {Single}. Person who worked 10 years for SS is {Me, Neither}.

### Rule Number: 16

Statement: If the current screen is {incSSBenefit} then the next screen is {incSSSpouse}. Direction is {Backward}. Marital status is {Single}. Person who worked 10 years for SS is {Spouse}. The user was not married to their former spouse for 10 years or more.

### Rule Number: 17

Statement: If the current screen is {incSSBenefit} then the next screen is {incSSWidowed}. Direction is {Backward}. Marital status is {Single}. Person who worked 10 years for SS is {Spouse}. The user was married to the spouse for 10 or more years.

### Rule Number: 18

Statement: If the current screen is {incSSBeginDate} then the next screen is {incEmploy}. Direction is {Forward}. Marital status is {Single}.

To achieve results satisfactory to the user, the amount of time required by the user to complete data entry should be no more than one hour, although it is understood that for systems having greater levels of complexity in distinguishing between recommendations based on greater granularity in the data collected from the user, much more time may be needed. Because the system is stateless, the user's data can be saved and the process resumed at a later time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A system for recommending a retirement benefit plan, comprises:
a database including data relating to retirement benefit plans, each of said plans having a specific set of characteristics relating to retirement benefit plans and at least one value associated with each characteristic,
said plurality of characteristics including at least one characteristic relating to benefit plan costs and at least one characteristic relating to benefit plan beneficiary;
an inference rules engine stored on a computer readable medium and processed on a computer processor, said rules engine having a plurality of rules, at least one of said rules relating at least one specific characteristic to another characteristic;
all of said rules returning a result;
a computer program for generating questions based on said rules and the characteristics in the rules, said computer program storing on a computer readable medium responses to the question in the form of beneficiary data;
said rules engine for searching said rules by comparing said beneficiary data against the values of the characteristics of the rules; and
a computer output device for displaying a recommendation of a particular retirement benefit plan if at least all of the values of the characteristics of the rule are met by the beneficiary data and if the rule has a particular retirement benefit plan as its result,
wherein rules whose characteristic values are not met by stored beneficiary data corresponding to that characteristic are not used by the computer program for generating further questions.

2. The system of claim 1, wherein a result of a rule in the plurality of rules is stored as beneficiary data.

3. The system of claim 2, wherein the result of the rule is an indication that the beneficiary is eligible for a retirement benefit plan, but does not recommend that plan.

4. The system of claim 1, wherein the characteristics of a rule include beneficiary's age, marital status, and employment status.

5. The system of claim 1, wherein the characteristics of a rule include beneficiary's income.

6. The system of claim 1, wherein the computer program generating the questions is programmed to generate questions in an order that eliminates a maximum number of rules from use in generating subsequent questions.

7. The system of claim 1, wherein the database, rules engine, and computer program for generating questions reside on a server;
the computer program generates questions that are displayed to a user on a client connected to said server by a network; and
the user enters responses to the questions on the client.

8. The system of claim 7, wherein the server is a web server, the client is an internet browser.

9. A computerized method of recommending a retirement benefit plan, comprising:
storing in a computer readable medium a plurality of rules in the form of conditional statements having a condition and a result, at least one of said rules having at least one specific value for at least one characteristic associated with an eligibility requirement of a retirement plan in the condition, an having the name of the plan in the result;
generating a plurality of questions based on said rules, at least one of said questions asking for data about a plan beneficiary;
receiving data about a plan beneficiary;
processing data about said plan beneficiary and comparing said data to said specific value of the condition of the at least one rule; and
outputting a report recommending a retirement benefit plan corresponding to the plan in the result of the statement of the at least one rule if the condition is satisfied.

10. The computerized method of recommending a retirement benefit plan according to claim 9, further comprising identifying all of the rules whose conditions are not satisfied by the data received and eliminating these rules as a basis for generating subsequent questions.

11. The computerized method of recommending a retirement benefit plan according to claim 9, wherein said rule includes the value less than 65 for the characteristic relating to beneficiary's age in the condition and a recommendation for COBRA in the result.

12. The computerized method of recommending a retirement benefit plan according to claim 9, wherein said rule includes the value over 65 for the characteristic relating to beneficiary's age in the condition and a recommendation for Medicare in the result.

13. The computerized method of recommending a retirement benefit plan according to claim 9, wherein said rule includes age and employment status in the condition.

14. The computerized method of recommending a retirement benefit plan according to claim 9, wherein said rule includes marital status and employment status in the condition.

15. The computerized method of recommending a retirement benefit plan according to claim 9, further comprising identifying all of the rules whose conditions are not satisfied by the results of rules whose conditions are satisfied, and eliminating said unsatisfied rules as a basis for generating subsequent questions.

16. An network application, comprising:
a web server storing in a computer readable medium a plurality of rules in the form of conditional statements having a condition and a result, at least one of said rules having at least one specific value for at least one characteristic associated with an eligibility requirement of a retirement plan in the condition, an having the name of the plan in the result;
a computer program running on said web server generating a plurality of questions based on said rules, at least one of said questions asking for data about a plan beneficiary; said program identifying all of the rules whose conditions are not satisfied by the data received and eliminating these rules as a basis for generating subsequent questions;
receiving data about a plan beneficiary from a web browser connected to a web server over the internet;
processing data on said web server about said plan beneficiary and comparing said data to said specific value of the condition of the at least one rule; and
outputting a report to the web browser recommending at least one retirement benefit plan corresponding to the plan in the result of the statement of the at least one rule if the condition is satisfied.

17. The network application of claim 16, further comprising identifying all of the rules whose conditions are not satisfied by the results of rules whose conditions are satisfied, and eliminating said unsatisfied rules as a basis for generating subsequent questions.

18. The network application of claim 16, wherein the computer program generates questions in an order that maximizes the number of rules eliminated from use in generating subsequent questions.

19. The network application of claim 16, wherein the computer program generates questions in an order that obtains beneficiary data relating to characteristics common across as many of the rules in the plurality of rules as possible.
